(19) United States
(12) Patent Application Publication
(10) Pub. No.: US 2011/0075108 A1
(43) Pub. Date: Mar. 31, 2011

(54) PROJECTION DISPLAY DEVICE

(75) Inventors: Kuniko Kojima, Tokyo (JP); Jun Kondo, Tokyo (JP); Yuzo Nakano, Tokyo (JP); Tomohiko Sawanaka, Tokyo (JP)

(73) Assignee: Mitsubishi Electric Corporation, Tokyo (JP)

(21) Appl. No.: 12/889,531

(22) Filed: Sep. 24, 2010

(30) Foreign Application Priority Data
Sep. 25, 2009 (JP) 2009-220783
Apr. 21, 2010 (JP) 2010-098220

(51) Int. Cl. G03B 21/20

(52) U.S. Cl. 353/38

(57) ABSTRACT

A projection display device that displays an image by projecting the image onto a transmissive screen from the rear thereof includes: an illumination optical system for guiding a light beam emitted from a laser light source to the transmissive screen; a projection optical system for enlarging an image formed on a region to be illuminated of an image display element, and projecting the enlarged image on the transmissive screen, the projection optical system being configured such that the product of the F-number and the projection magnification of the projection optical system is less than 400; wherein the transmissive screen includes a Fresnel lens and a lenticular lens respectively equipped with a light diffusion layer for diffusing incident light and causing resultant light to exit the light diffusion layer. The light diffusion layer of the lenticular lens has a thickness of less than 300 μm.

### BACKGROUND OF THE INVENTION

1. Field of the Invention

The present invention relates to a projection display device for displaying images by projecting the images onto a transmissive screen.

2. Description of the Related Art

Recent trend of a projection display device using a liquid crystal panel or a reflective light modulator (such as a reflective liquid crystal display element) as an image display element is configured to include a high-brightness light source in order to enhance brightness.

Extra-high pressure mercury lamps, metal halide lamps and other lamps have been used as light sources of the projection display device. When applied as light sources, these lamps have disadvantageously shortened their lifetimes, and have necessitated frequent maintenance tasks such as changing of lamps. These lamps have also required an optical system for taking red, green and blue colors out of white color of the lamps, resulting in a complicated device structure and degradation of light use efficiency.

Laser light sources such as semiconductor lasers have been used in order to solve these problems. Laser light sources have longer lifetimes than those of the conventionally employed lamps as light sources, and do not require any maintenance tasks for a long period of time. Furthermore, laser light sources can directly be modulated according to images to be displayed, thereby simplifying a device structure and increasing light use efficiency. Using laser light sources also advantageously expands a range of color reproduction.

In contrast, laser light sources have a high level of coherence. Therefore, using laser light sources as light sources of a projection display device causes interference between a light diffusing material in a transmissive screen and light. This generates glare (speckle noise or scintillation) on images to be displayed, resulting in degradation of image quality.

It has been desired that a projection display device has reduced speckle noise or scintillation. The following techniques have been suggested in order to achieve this object. According to one technique, the relationship between the exit pupil diameter and the projection distance of a projection lens, and the number of diffusion layers in a transmissive screen are defined (see Japanese Patent Application Laid-pen No. H8-313865). According to another technique, internal oscillation is caused in at least one of diffusion layers in a transmissive screen (see Japanese Patent Application Laid-open No. 2001-100317).

In the conventional technique disclosed in Japanese Patent Application Laid-open No. H8-313865, a ratio between the exit pupil diameter d and the projection distance a of a projection lens (d/a) is set to be no greater than 0.06. However, controlling the ratio d/a at a low level reduces the angle of divergence of light entering a transmissive screen, while worsening speckle noise or scintillation.

The conventional technique disclosed in Japanese Patent Application Laid-open No. 2001-100317 requires a mechanism for causing oscillation in a diffusion layer in a transmissive screen. This disadvantageously results in upsizing of a device while entailing high cost. Furthermore, the oscillation in the diffusion layer makes the operation of the device unstable, making it difficult to maintain reliability of image display at a high level.

### SUMMARY OF THE INVENTION

It is an object of the present invention to at least partially solve the problems in the conventional technology, and in order to solve the aforementioned problems, a projection display device for displaying an image by projecting the image onto a transmissive screen from a rear thereof according to one aspect of the present invention is constructed in such a manner as to comprise: a light source for emitting light; an illumination optical system for causing a light beam emitted from the light source to propagate through a predetermined optical path, and guiding the light beam to the transmissive screen; an image display element for forming an image on a region to be illuminated with a light beam guided by the illumination optical system, the image being intended to be displayed on the transmissive screen; a projection optical system for enlarging the image formed on the region of the image display element, and projecting the enlarged image on the transmissive screen; and the transmissive screen including a Fresnel lens for converting incident light to light with substantially parallel rays and causing the converted light to exit the Fresnel lens, the transmissive screen also including a lenticular lens for receiving light exiting the Fresnel lens, and causing the received light to exit the lenticular lens as predetermined diffusion light, wherein the projection optical system is configured such that a product of an F-number and a projection magnification of the projection optical system is less than 400, the Fresnel lens includes a first light diffusion layer for diffusing incident light and causing resultant light to exit the first light diffusion layer as first diffusion light, and the lenticular lens includes a second light diffusion layer for further diffusing the first diffusion light and causing resultant light to exit the second light diffusion layer as second diffusion light, either one of the first and second light diffusion layers having a thickness of less than 300 μm.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 shows the structure of a projection display device according to a first embodiment of the present invention;

FIG. 2 explains an idea of light propagation in a projection optical system of the projection display device according to the first embodiment of the present invention;

FIG. 3 explains glare observed on a transmissive screen of the projection display device according to the first embodiment of the present invention;

FIGS. 4A and 4B each show the relationship between the magnitude of the angle of divergence of light entering the transmissive screen and the diffusion characteristics of light exiting the transmissive screen in the projection display device according to the first embodiment of the present invention;

FIGS. 5 and 6 each show the relationship between the F-number of the projection optical system of the projection display device according to the first embodiment of the present invention and glare (speckle noise or scintillation);

FIGS. 7 and 8 each show the relationship between the value of Fp×M of the projection optical system according to the first embodiment of the present invention and glare;

FIGS. 9, 10, and 11 each show the structure of the transmissive screen of the projection display system according to the first embodiment of the present invention;

FIGS. 12 and 13 each show the relationship between the thickness of a light diffusion layer in the transmissive screen of the projection display device according to the first embodiment of the present invention and glare;

FIGS. 14 and 15 each show the relationship among the thickness of the light diffusion layer in the transmissive screen according to the first embodiment of the present invention, glare and a resolution level;

FIG. 16 shows the relationship of a distance between diffusion layers of a projection display device according to a second embodiment of the present invention with speckle noise and scintillation;

FIG. 17 shows the relationship of a distance between the diffusion layers of the projection display device according to the second embodiment of the present invention with speckle noise and scintillation, and with a resolution level;

FIGS. 18, 19, and 20 each show the structure of a transmissive screen of the projection display system according to the second embodiment of the present invention;

FIGS. 21 and 22 each illustrate glare observed on the transmissive screen of the projection display device according to the second embodiment of the present invention;

FIGS. 23 and 24 each show the relationship between the haze value of a transmissive screen of a projection display device according to a third embodiment of the present invention and glare;

FIGS. 25 and 26 each show the structure of an optical system of a projection display device according to a fourth embodiment of the present invention;

FIGS. 27 and 28 each show the structure of an optical system of a projection display device according to a fifth embodiment of the present invention;

FIGS. 29, 30, 31, and 32 each show the structure of an optical system of a projection display device according to a sixth embodiment of the present invention; and

FIG. 33 shows the structure of a projection display device according to a seventh embodiment of the present invention.

### DETAILED DESCRIPTION OF THE PREFERRED EMBODIMENTS

Next, embodiments of a projection image display according to the present invention will be described in detail with reference to the accompanying drawings. It should be noted that the embodiments described below are not intended to limit the present invention.

### First Embodiment

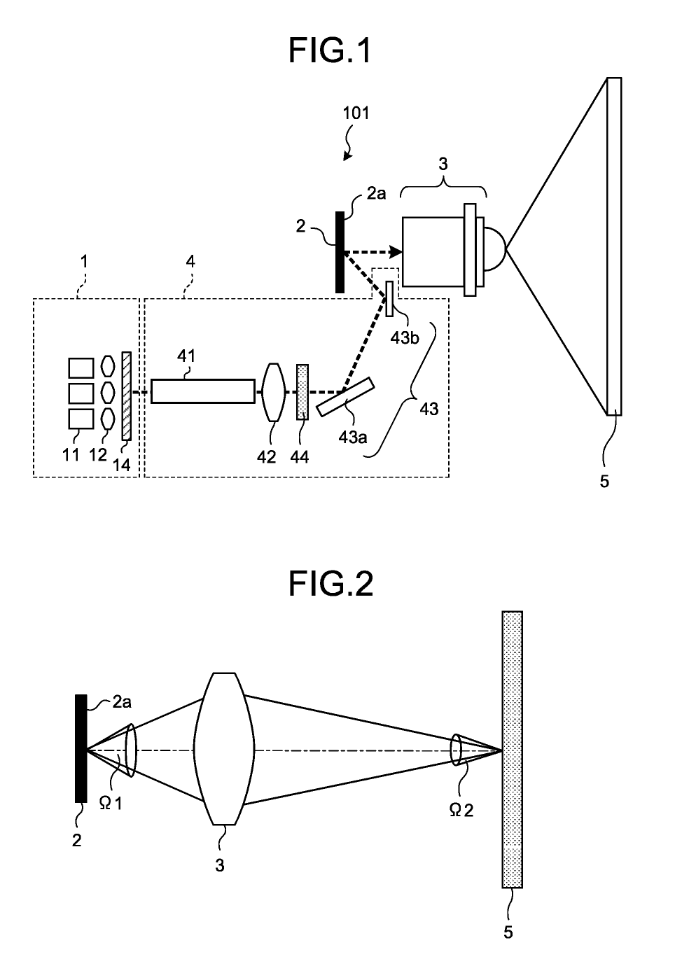

FIG. 1 shows the structure of a projection display device according to a first embodiment of the present invention. A projection display device 101 is a rear-projection image display device for projecting images on a screen by using a light bulb.

As shown in FIG. 1, the projection display device 101 according to the first embodiment includes a light-collecting optical system 1, an illumination optical system 4, a reflective light modulator (reflective light bulb) 2 functioning as an image display element, and a projection optical system 3 for enlarging an image on a to-be-illuminated surface (image-forming region) 2a of the reflective light modulator 2 illuminated with the illumination optical system 4, and projecting the enlarged image onto a transmissive screen 5.

The light-collecting optical system 1 includes laser light sources 11 of multiple colors (in FIG. 1, three colors), and multiple (in FIG. 1, three) light-collecting lenses (light-collecting parts) 12 composed of one or a plurality of lenses or mirrors for collecting light beams emitted from the laser light sources 11.

In the light-collecting optical system 1, each of the laser light sources 11 has a one-to-one correspondence with each of the light-collecting lenses 12. Accordingly, a light beam emitted from one of the laser light sources 11 is transferred through the corresponding light-collecting lens 12 to a wave plate for changing polarization (polarization changing part) 14. The polarization component of the light beam of each of the laser light sources 11 is subjected to a phase difference introduced by the wave plate 14, and then the light beam is guided to the illumination optical system 4.

The projection display device 101 changes the polarization directions of the laser light sources 11 by the action of the wave plate 14, thereby relaxing coherence thereof. While shown to be arranged behind the light-collecting lenses 12 (in a subsequent stage to the light-collecting lenses 12) in FIG. 1, the wave plate 14 may alternatively be arranged behind the laser light sources 11 (in a subsequent stage to the laser light sources 11), or may be provided within the illumination optical system 4.

The illumination optical system 4 includes a light intensity equalizer 41 for providing uniformity in the intensity distribution of light beams emitted from the light-collecting optical system 1, a relay lens group 42, a diffusing element 44, and a mirror group 43 composed of a first mirror 43a and a second mirror 43b. In the illumination optical system 4, light beams emitted from the light intensity equalizer 41 are guided by the relay lens group 42 and the mirror group 43 to the reflective light modulator 2.

The light intensity equalizer 41 has a function to provide uniformity in the light intensity of light beams emitted from the light-collecting optical system 1 (such as a function to reduce nonuniformity in illumination level). The light intensity equalizer 41 is arranged in the illumination optical system 4 such that its light incident surface (incident end surface) through which light enters faces the light-collecting lenses 12, and that its light exit surface (exit end surface) through which light exits the light intensity equalizer 41 faces the relay lens group 42. The light intensity equalizer 41 is made of, for example, a transparent material such as glass or resin. The light intensity equalizer 41 may include a rod of a polygonal columnar shape (columnar member that is polygonal in cross section) configured such that its inner side wall functions as a total reflection surface. Or, the light intensity equalizer 41 may include a pipe that is polygonal in cross section (tubular member) formed into a tubular shape such that its inner surface functions as a light reflecting surface.

When the light intensity equalizer 41 is a rod of a polygonal columnar shape, light is caused to reflect several times by using total reflection occurring at the interface between the transparent material and air. Then, the light exits the light intensity equalizer 41 through the exit end (light exit). When the light intensity equalizer 41 is a polygonal pipe, light is caused to reflect several times by using the reflex action of an inward-facing surface mirror. Then, the light exits the light intensity equalizer 41 through the light exit.

As long as the light intensity equalizer 41 has an appropriate length in a direction in which light beams travel, light beams having reflected several times inside the light intensity equalizer 41 are superposed and applied to a region near the light exit surface of the light intensity equalizer 41. This provides substantially uniform intensity distribution in the region near the light exit surface of the light intensity equalizer 41. The light exiting the light intensity equalizer 41 through the light exit surface and having a substantially uniform intensity distribution is guided by the relay lens group 42 and the mirror group 43 to the reflective light modulator 2, and are applied to the to-be-illuminated surface 2a of the reflective light modulator 2.

The illumination optical system 4 includes the diffusing element (diffusing part) 44 provided in a subsequent stage to the relay lens group 42. The diffusing element 44 diffuses light propagating through the relay lens group 42 and transfers the diffused light to the mirror group 43, thereby reducing speckle. The diffusing element 44 may be a holographic diffusing element capable of setting angle of diffusion of light according to a hologram pattern formed on a substrate. The diffusing element 44 relaxes the coherence of the laser light sources 11. Giving motion of the diffusing element 44 such as rotation or oscillation effectively relaxes coherence of the laser light sources 11.

While shown to be arranged in a subsequent stage to the relay lens group 42 in FIG. 1, the diffusing element 44 is not necessarily located in this position. As an example, the diffusing element 44 may be arranged in front of or behind the light intensity equalizer 41. As another example, a plurality of diffusing elements 44 may be arranged in combination to effectively relax the coherence of the laser light sources 11.

As an example, a DMD (digital micro-mirror device, a registered trademark) is used as the reflective light modulator 2. The reflective light modulator 2 is composed of a large number of movable micro-mirrors each corresponding to a pixel (hundreds of thousands of micro-mirrors, for example) arranged two-dimensionally, in such a way that the tilt angle of each micro-mirror is changed in response to pixel information.

While the illustrated relay lens group 42 is composed of a single lens in FIG. 1, the number of lenses constituting the relay lens group 42 is not limited to one, but may be two or more. Likewise, the number of mirrors constituting the mirror group 43 is not limited to two, but may be one, or three or more.

Light propagation through an optical path in the projection optical system 3 will be described next. FIG. 2 illustrates the idea of light propagation in a projection optical system, and conceptually shows the operation of the projection optical system 3 (including the F-number and the projection magnification of the projection optical system). The projection optical system 3 is shown to be a single lens element in FIG. 2 in order for its schematic illustration.

The projection optical system 3 of the present embodiment is configured such that the to-be-illuminated surface 2a of the reflective light modulator 2 and the transmissive screen 5 optically conjugate with each other. In FIG. 2, the size S1 and the angle of divergence Ω1 [deg] of the to-be-illuminated surface 2a of the reflective light modulator 2, and the size S2 and the angle of divergence Ω2 [deg] of the transmissive screen 5 are geometrically and optically related to each other as shown by the following formula (1). The angle of divergence Ω1 is the maximum cone angle of light emitted from the reflective light modulator 2, and the angle of divergence Ω2 is the maximum cone angle of light received by the transmissive screen 5.

S1×Ω1=S2×Ω2 (1)

The F-number (Fp) of the projection optical system 3 is defined by the following formula (2) by using the angle of divergence Ω1 [deg] of the reflective light modulator 2:

Fp=1/(2×sin(Ω1/2)) (2)

The projection magnification M of the projection optical system 3 represents a ratio by which the size S1 of the to-be-illuminated surface 2a of the reflective light modulator 2 is magnified to the size S2 of the transmissive screen 5, and is determined by using the following formula (3):

M=S2/S1 (3).

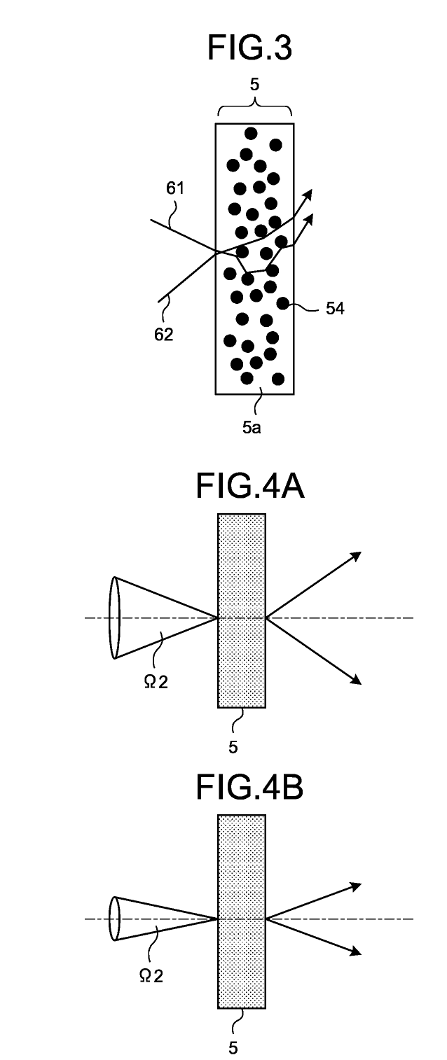

Next, speckle noise or scintillation observed on the transmissive screen 5 will be described with reference to FIG. 3, which illustrates for explaining speckle noise or scintillation observed on the transmissive screen. FIG. 3 briefly shows how glare (scintillation) is generated on the transmissive screen 5.

Even when entering the transmissive screen 5 through the same position and at different angles, light beams 61 and 62 are caused to exit the transmissive screen 5 in the same direction by a diffusion layer 5a (containing diffusing materials 54) in the transmissive screen 5. Some light beams are caused to exit the transmissive screen 5 in different directions by the diffusion layer 5a in the transmissive screen 5 even when entering the transmissive screen 5 through different positions and at the same angle. This means that light beams entering the transmissive screen 5 through respective positions and at respective angles are diffused in respective directions by the diffusion layer 5a in the transmissive screen 5, and then exit the transmissive screen 5 through respective resultant positions and at respective resultant angles. Accordingly, the light beams 61 and 62 exiting the diffusion layer 5a reinforce each other or cancel each other out, thereby generating brightness difference between their exiting positions. This brightness difference is observed as glare in the form of speckle noise or scintillation.

In response, the present embodiment defines the angle of divergence Ω2 of light entering the transmissive screen 5 determined by the F-number Fp and the projection magnification M of the projection optical system 3. FIGS. 4A and 4B each show the relationship between the magnitude of the angle of divergence of light entering a transmissive screen and the diffusion characteristics of light exiting the transmissive screen. FIGS. 4A and 4B each briefly show the relationship between the F-number of a projection optical system and scintillation. FIG. 4A shows the case where the angle of divergence Ω2 [deg] of light entering the transmissive screen 5 is large, whereas FIG. 4B shows the case where it is small.

As seen from FIGS. 4A and 4B, light is diffused to a greater degree when exiting the transmissive screen 5 with the greater angle of divergence Ω2 [deg] of the light when entering the transmissive screen 5. This means the greater angle of divergence Ω2 [deg] of light entering the transmissive screen 5 results in a greater degree of diffusion of the light, thereby relaxing glare.

The angle of divergence Ω2 [deg] of light entering the transmissive screen 5 is calculated from the formula (1) using the size S1 and the angle of divergence Ω1 [deg] of the to-be-illuminated surface 2a of the reflective light modulator 2, and the size S2 of the transmissive screen 5. This translates into the fact that the angle of divergence Ω2 [deg] is determined by the F-number Fp and the projection magnification M of the projection optical system 3. Results of experiment conducted on glare on the transmissive screen 5 are given below that are obtained by changing the F-number Fp and the projection magnification M of the projection optical system 3.

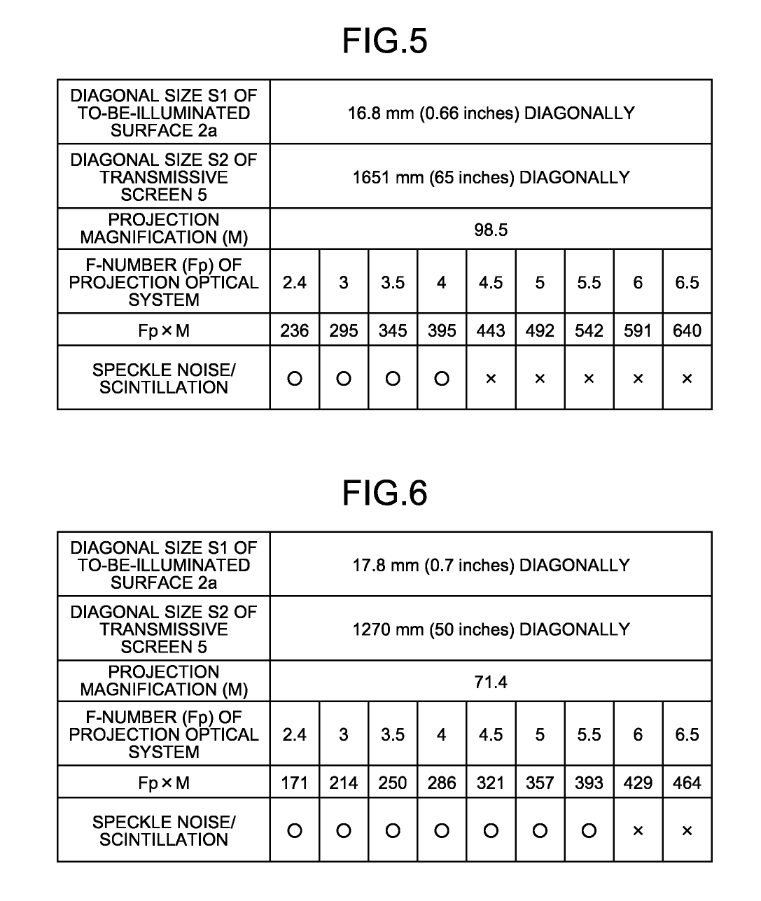

FIGS. 5 and 6 each show the relationship between the F-number of a projection optical system and glare. The results of experiment shown in FIG. 5 are obtained with the diagonal size S1 of the to-be-illuminated surface 2a of the reflective light modulator 2 being 16.8 mm (0.66 inches), and with the diagonal size S2 of the transmissive screen 5 being 1651 mm (65 inches). In this case, the projection magnification M is determined as 98.5 from the formula (3). FIG. 5 shows the levels of speckle noise or scintillation (acceptable levels are indicated by circles and unacceptable levels are indicated by crosses) when the projection magnification M is 98.5 and the F-number Fp of the projection optical system 3 is gradually changed from 2.4 to 6.5.

Change in speckle noise and scintillation on the transmissive screen 5 as a result of change in the F-number Fp of the projection optical system 3 was observed. As a result, it has also been found that speckle noise and scintillation are at the allowable levels when the F-number Fp of the projection optical system 3 falls within a range of from 2.4 to 4.

In contrast, it has been found that speckle noise and scintillation are worsened when the F-number Fp of the projection optical system 3 is equal to or greater than 4.5. Accordingly, it has been found that speckle noise and scintillation are at the allowable levels when the F-number Fp of the projection optical system 3 falls within a range of from 2.4 to 4. In this case, the product of the F-number Fp and the projection magnification M of the projection optical system 3 is less than 443 and no greater 395, namely it satisfies a requirement that it should be no greater than 400.

The results of experiment shown in FIG. 6 are obtained with the diagonal size S1 of the to-be-illuminated surface 2a of the reflective light modulator 2 being 17.8 mm (0.7 inches), and with the diagonal size S2 of the transmissive screen 5 being 1270 mm (50 inches). That is, the results of experiment shown in FIG. 6 are obtained with the projection display device 101 being configured such that the projection magnification M (71.4) in FIG. 6 is smaller than that in FIG. 5.

Like those observed in the projection display device 101 shown in FIG. 5, change in speckle noise and scintillation on the transmissive screen 5 as a result of change in the F-number Fp of the projection optical system 3 was observed in the projection display device 101 shown in FIG. 6. As a result, it has been found that speckle noise and scintillation are at the allowable levels when the F-number Fp of the projection optical system 3 falls within a range of from 2.4 to 5.5. Accordingly, as in the case of FIG. 5, it has been found that speckle noise and scintillation are at the allowable levels when the product of the F-number Fp and the projection magnification M of the projection optical system 3 is less than 429 and not greater than 393, namely when it satisfies a requirement that it should be no greater than 400.

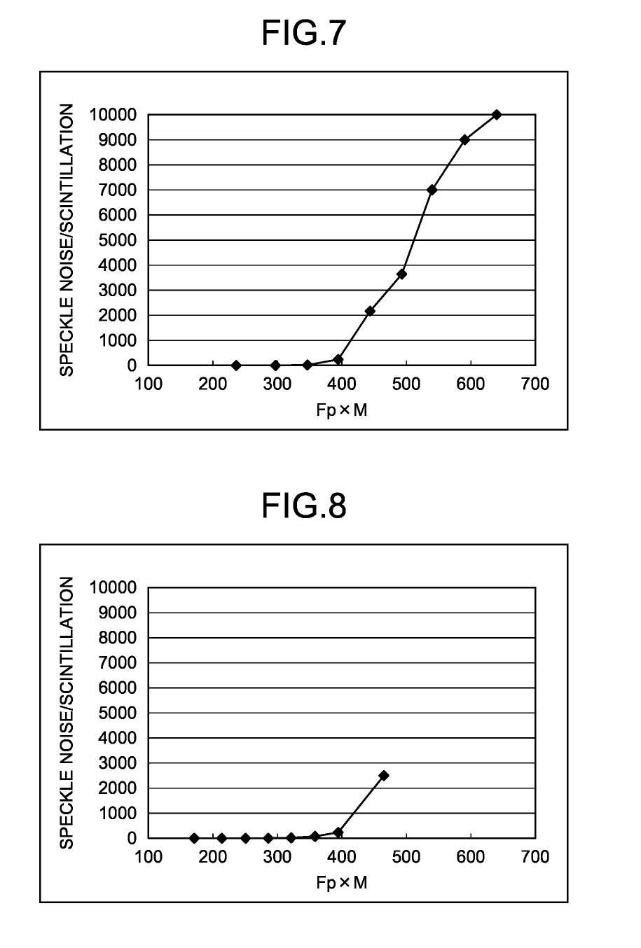

FIGS. 7 and 8 show the speckle noise and scintillation shown in FIGS. 5 and 6 respectively that are represented by numerical values in order to facilitate understanding thereof. Speckle noise and scintillation are evaluated by counting the number of pixels of brightness levels that are the same as or greater than a certain threshold value with respect to an average brightness level on a screen.

It is seen from FIGS. 7 and 8 that change in the evaluated value of speckle noise and scintillation as a result of change in the value of Fp×M clearly differ between the case where the value of Fp×M is greater than 400 and in the case where the value of Fp×M is smaller than 400. More specifically, the evaluated value of speckle noise and scintillation decreases significantly with decrease in the value of Fp×M when the value of Fp×M is greater than 400. In this case, it is seen that decrease in the value of Fp×M is effective in alleviating speckle noise and scintillation. In contrast, the evaluated value of speckle noise and scintillation decreases slightly with a decrease in the value of Fp×M when the value of Fp×M is smaller than 400. In this case, it is seen that a decrease in the value of Fp×M is less effective in alleviating speckle noise and scintillation.

As understood from the foregoing, the illumination optical system 4 is allowed to alleviate speckle noise and scintillation effectively when the value of Fp×M satisfies a requirement that it should be no greater than 400, more specifically when it satisfies a requirement that it should be no greater than 395 or 393 in light of the values obtained by the results of experiment.

The aforementioned experiments were conducted under conditions that a distance TFLo between the light incident surface of a first diffusion layer and the light exit surface of a second diffusion layer discussed later (distance between the outer surfaces of the diffusion layers, namely maximum distance between the diffusion layers) is 5.1 mm, respective thicknesses DTF and DTL of diffusion layers 51a and 52a are both 275 μm, and haze values H1 and H2 of a Fresnel lens (Fresnel lens sheet) 51 and a lenticular lens (lenticular lens sheet) 52 discussed later are 40% and 90%, respectively.

As is described later, speckle noise and scintillation are alleviated to a greater degree with increase in the haze value H1. As long as the haze value H1 is about 40% or higher, speckle noise and scintillation are effectively alleviated when the value of Fp×M satisfies a requirement that it should be no greater than 400, more specifically when it satisfies a requirement that it should be no greater than 395 or 393 in light of the values obtained by the results of experiment.

The haze value H2 set to be greater than the haze value H1 is effective for avoiding reduction in a resolution level. As long as the haze value H2 is in a range of from about 80% to 95%, speckle noise and scintillation are effectively alleviated when the value of Fp×M satisfies a requirement that it should be no greater than 400, more specifically when it satisfies a requirement that it should be no greater than 395 or 393 in light of the values obtained by the results of experiment.

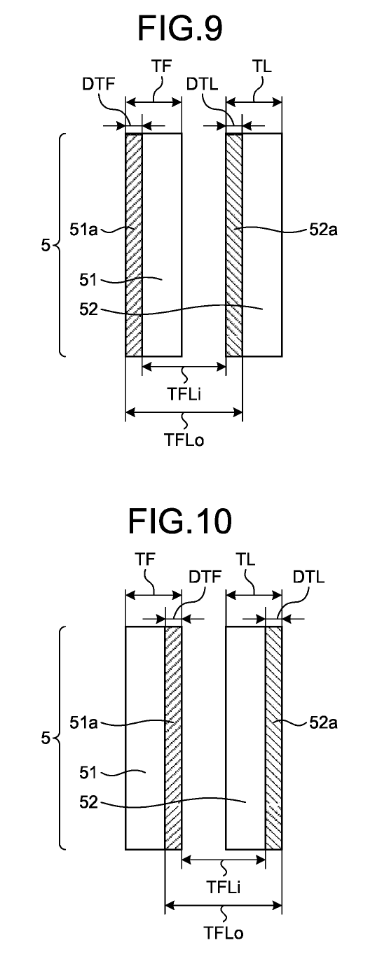

FIGS. 9 to 11 each show the structures of a transmissive screen. The transmissive screen 5 constituting the optical system of the projection display device 101 includes the Fresnel lens (Fresnel lens sheet) 51 for converting incident light to light with substantially parallel rays, and causing the converted light to exit the Fresnel lens 51. The transmissive screen 5 also includes the lenticular lens (lenticular lens sheet) 52 for receiving light exiting the Fresnel lens 51, and causing the received light to exit the lenticular lens 52 as predetermined diffusion light. The transmissive screen 5 includes the diffusion layers 51a and 52a together with the Fresnel lens 51 and the lenticular lens 52.

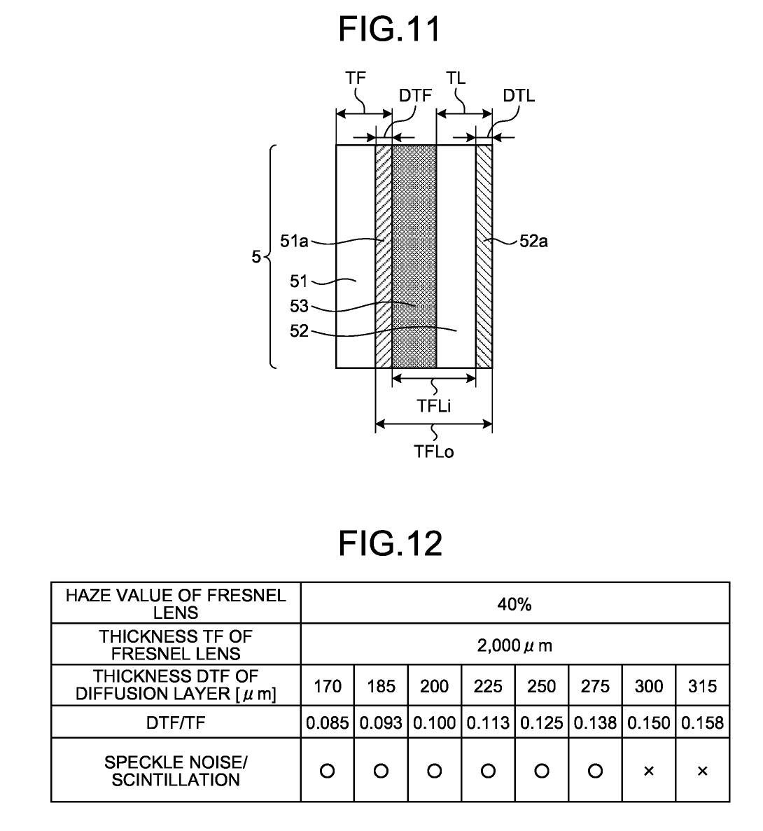

The transmissive screen 5 will be described next with reference to FIGS. 9 to 11 to show examples of the diffusion layers 51a and 52a. In the transmissive screen 5 shown in FIG. 9, the diffusion layers 51a and 52a are arranged on the respective light incident sides of the Fresnel lens 51 and the lenticular lens 52. In the transmissive screen 5 shown in FIG. 10, the diffusion layers 51a and 52a are arranged on the respective light exit sides of the Fresnel lens 51 and the lenticular lens 52. The transmissive screen 5 shown in FIG. 11 has an intermediate layer 53 between the Fresnel lens 51 and the lenticular lens 52. The intermediate layer 53 in FIG. 11 is formed from a glass or acrylic flat plate, for example, and has a function to enhance rigidity of the transmissive screen 5.

The combination of the Fresnel lens 51 and the lenticular lens 52 is not limited to those shown in FIGS. 9 to 11. The Fresnel lens 51 and the lenticular lens 52 may be combined in alternative ways. Further, the transmissive screen 5 may have three or more diffusion layers.

In FIGS. 9 to 11, the Fresnel lens 51, the diffusion layer 51a of the Fresnel lens 51 as the first diffusion layer, the lenticular lens 52, and the diffusion layer 52a of the lenticular lens 52 as the second diffusion layer have thicknesses called TF, DTF, TL, and DTL, respectively. Change in speckle noise and scintillation on the transmissive screen 5 was observed that was caused as a result of change in the relationship between the thicknesses TF and DTF of the Fresnel lens 51 and the diffusion layer 51a, or in the relationship between the thicknesses TL and DTL of the lenticular lens 52 and the diffusion layer 52a.

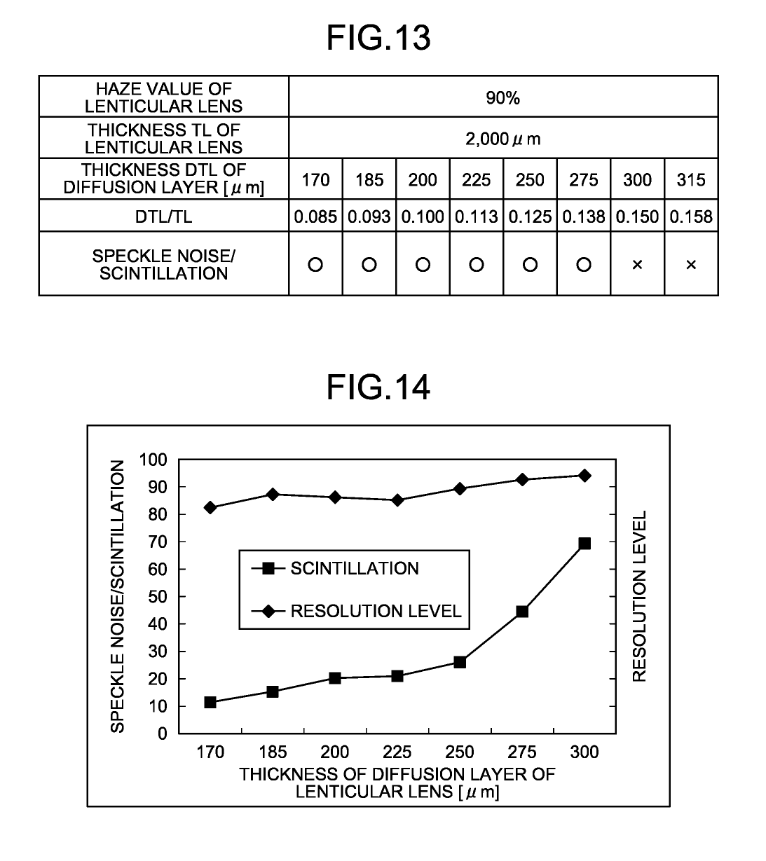

FIGS. 12 and 13 each show the relationship between the thickness of a light diffusion layer of a transmissive screen and glare. The diffusion layers 51a and 52a each contain a diffusing material, and the amount of the diffusing material contained is expressed by a haze value (in percentage). FIG. 12 shows the levels of speckle noise or scintillation (acceptable levels are indicated by circles and unacceptable levels are indicated by crosses) when the thickness DTF of the diffusion layer 51a is changed from 170 μm to 315 μm while the haze value H1 of the diffusion layer 51a of the Fresnel lens 51 is 40% and the thickness TF of the Fresnel lens 51 is 2000 μm. At this time, the haze value H2 of the diffusion layer 52a of the lenticular lens 52 is 90%, and the thicknesses TL and DTL of the lenticular lens 52 and the diffusion layer 52a are 2000 μm and 275 μm, respectively. Furthermore, the aforementioned value of Fp×M is 330.

Changes in speckle noise and scintillation on the transmissive screen 5 as a result of change in the thickness DTF of the diffusion layer 51a of the Fresnel lens 51 were observed. As a result, it has been found that speckle noise and scintillation are at the allowable levels when the ratio of the thickness (DTF) of the diffusion layer to the thickness (TF) of the Fresnel lens is less than 0.150 and not greater than 0.138, namely when the thickness of the diffusion layer (DTF) is less than 300 μm and not greater than 275 μm. The same results are obtained as long as the haze value H1 is about 40% or higher, and the haze value H2 is in a range of about 80 to 95%.

FIG. 13 shows the levels of speckle noise or scintillation (acceptable levels are indicated by circles and unacceptable levels are indicated by crosses) when the thickness DTL of the diffusion layer 52a is changed from 170 μm to 315 μm while the haze value H2 of the diffusion layer 52a of the lenticular lens 52 is 90% and the thickness TL of the lenticular lens 52 is 2000 μm. At this time, the haze value H1 of the diffusion layer 51a of the Fresnel lens 51 is 40%, and the thicknesses TF and DTF of the Fresnel lens 51 and the diffusion layer 51a are 2000 μm and 275 μm, respectively. Furthermore, the aforementioned value of Fp×M is 330.

Change in speckle noise and scintillation on the transmissive screen 5 as a result of change in the thickness DTL of the diffusion layer 52a of the lenticular lens 52 was observed. As a result, it has been found that speckle noise and scintillation are at the allowable levels when the ratio of the thickness (DTL) of the diffusion layer to the thickness (TL) of the lenticular lens is less than 0.150 and no greater than 0.138, namely when the thickness (DTL) of the diffusion layer is less than 300 μm and no greater than 275 μm. The same results are obtained as long as the haze value H1 is about 40% or higher, and the haze value H2 is in a range of from about 80% to 95%.

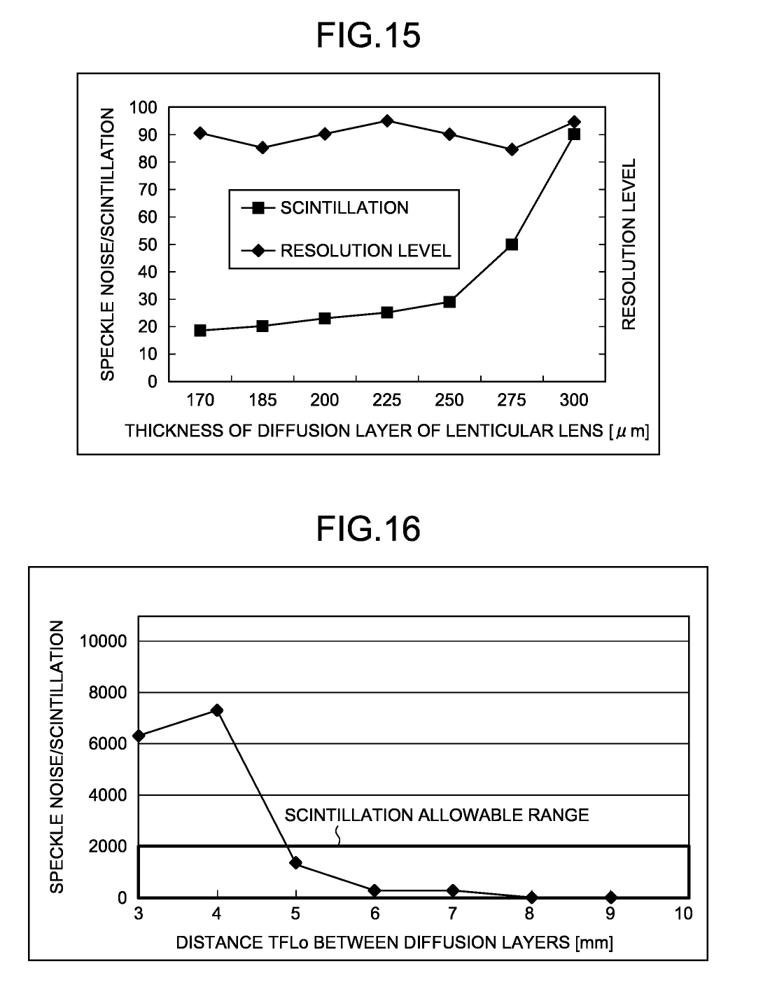

FIGS. 14 and 15 show the speckle noise and scintillation shown in FIGS. 12 and 13, respectively, that are represented by numerical values in order to facilitate understanding thereof. Speckle noise and scintillation are evaluated by counting the number of pixels of brightness levels that are the same as or greater than a certain threshold value with respect to an average brightness level on a screen. In the legends of FIGS. 14 and 15, speckle noise and scintillation are expressed collectively merely as scintillation due to a lack of space. Furthermore, speckle noise and scintillation are indicated by squares (lower plot), and a resolution level is indicated by rhombuses (upper plot).

It is seen from FIGS. 14 and 15 that changes in the evaluated value of speckle noise and scintillation as a result of change in the thicknesses DTF and DTL of the diffusion layers clearly differs between the case where the thicknesses DTF and DTL are greater than 250 μm and the case where the thicknesses DTF and DTL are smaller than 250 μm. More specifically, the evaluated value of speckle noise and scintillation decreases significantly with a reduction in the thicknesses DTF and DTL of the diffusion layers when the thicknesses DTF and DTL are greater than 250 μm. In this case, it is seen that reduction in the thicknesses DTF and DTL is effective in alleviating speckle noise and scintillation. In contrast, the evaluated value of speckle noise and scintillation decreases slightly with a reduction in the thicknesses DTF and DTL when the thicknesses DTF and DTL are smaller than 250 μm. In this case, it is seen that decrease in the thicknesses DTF and DTL is less effective in alleviating speckle noise and scintillation.

FIGS. 14 and 15 each show a resolution level together with the evaluated value of speckle noise and scintillation. Image quality degrades with a reduction in a resolution level, thereby generating severe blur of images. It is seen from FIGS. 14 and 15 that changes in the thicknesses DTF and DTL of the diffusion layers cause substantially no change in a resolution level. This means that speckle noise and scintillation are alleviated by reducing the thicknesses DTF and DTL without lowering a resolution level.

A resolution level is determined by the CTF (contrast transfer function). More specifically, an image with a group of uniformly spaced lines is displayed on a screen. When white and black lines appear alternately on the screen, black levels stand out clearly in a projected image. When the maximum and minimum of the intensity of a projected image are defined as Pmax and Pmin, respectively, CTF indicative of resolution performance is obtained from the following formula (4):

CTF=100×(Pmax−Pmin)/(Pmax+Pmin) (4)

In this case, a CTF value decreases with a reduction in resolution when a difference between the light intensities at Pmax and Pmin becomes small. In contrast, a CTF value increases with an increase in resolution when a difference between the light intensities at Pmax and Pmin becomes large.

As understood from the foregoing, speckle noise and scintillation are effectively alleviated by the thicknesses DTF and DTL of the diffusion layers without lowering a resolution level when the thicknesses DTF and DTL both satisfy a requirement that they should be no greater than 250 μm.

Requirements for the thicknesses DTF and DTL of the diffusion layers of the Fresnel lens (Fresnel lens sheet) 51 with a haze value of 40% and of the lenticular lens (lenticular lens sheet) 52 with a haze value of 90%, are both such that they should be no greater than 250 μm. This means that a haze value has little influence when the thicknesses DTF and DTL are both no greater than 250 μm.

Next, alleviation of speckle noise and scintillation by the thicknesses DTF and DTL of the diffusion layers, and alleviation of speckle noise and scintillation by the value of Fp×M are compared. The value of Fp×M, and the thicknesses DTF and DTL have their respective effects in alleviating speckle noise and scintillation. However, in the first embodiment, speckle noise and scintillation are alleviated first by decreasing the value of Fp×M, and then by reducing the thicknesses DTF and DTL.

The reason for doing so is as follows. Regarding alleviation by the value of Fp×M, decreasing the value of Fp×M from its normally applied value that is around 600 to the aforementioned value that is around 400 results in a difference of about 9700 in speckle noise and scintillation. In terms of ratio, alleviated speckle noise and scintillation are about 0.024 times those before alleviation. Regarding alleviation by reducing the thicknesses DTF and DTL of the diffusion layers, reducing the thicknesses DTF and DTL from their normally applied values that are around 300 μm to 250 μm results in a difference of about 44 to 61 in speckle noise and scintillation. In terms of ratio, alleviated speckle noise and scintillation are about 0.3 to 0.4 times those before alleviation.

When the alleviation is considered in terms of ratio, speckle noise and scintillation alleviated by the value of Fp×M is 0.024 times those before alleviation. Speckle noise and scintillation alleviated by the thicknesses DTF and DTL of the diffusion layers are about 0.3 to 0.4 times those before alleviation. If the thicknesses DTF and DTL results in the alleviation of about 0.35 times, the relation of 0.35/0.024=14.6 is established. That is, it is seen that the value Fp×M alleviates speckle noise and scintillation is about 15 times more effectively than the thinned thicknesses DTF and DTL. It is understood accordingly that, when speckle noise and scintillation are alleviated first by the value of Fp×M and then by reducing the thicknesses DTF and DTL of the diffusion layers, adverse effect to be caused by decreasing the value of Fp×M and reducing the thicknesses DTF and DTL in designing the structure of the projection display device 101 is minimized. It is also understood that speckle noise and scintillation are alleviated without requiring excessive cost.

By the way, decreasing the value of Fp×M increases the size of the projection optical system 3 and makes formation of a lens difficult, thereby making downsizing of the projection optical system 3 difficult. In contrast, reducing the thicknesses DTF and DTL of the diffusion layers makes formation of the Fresnel lens 51 and the lenticular lens 52 difficult. Thus, in considering the overall structure of the projection display device 101, it is important to first take an action that may be more effective in alleviating speckle noise and scintillation within a range that allows formation of the lenses, and then to take less effective action in order to make up for a deficit to achieve a target.

Accordingly, in the present embodiment, the projection display device 101 is configured such that the value of Fp×M satisfies a requirement that it should be no greater than 400, more specifically it should be no greater than 395 or 393 in light of the values obtained by the results of experiment. As a result, the angle of divergence of light entering the transmissive screen 5 falls within a predetermined range.

In the present embodiment, the ratio of the thickness (DTF) of the diffusion layer to the thickness (TF) of the Fresnel lens, that is the relationship between the thickness TF of the Fresnel lens 51 and the thickness DTF of the first diffusion layer 51a, is set to be less than 0.150 and no greater than 0.138. Namely, the thickness (DTF) of the diffusion layer is set to be less than 300 μm and no greater than 275 μm. Further, in the present embodiment, the ratio of the thickness (DTL) of the diffusion layer to the thickness (TL) of the lenticular lens, that is the relationship between the thickness TL of the lenticular lens 52 and the thickness DTL of the second diffusion layer 52a, is also set to be less than 0.150 and no greater than 0.138. Namely, the thickness (DTL) of the diffusion layer is set to be less than 300 μm and no greater than 275 μm. In the present embodiment, the reflective light modulator 2 is used as a light bulb of the projection display device 101. A light bulb of different types such as a transmissive or reflective liquid crystal display element may alternatively be used in the projection display device 101. Furthermore, while the laser light sources 11 are used in the first embodiment, light sources of different types such as extra high pressure mercury lamps and metal halide lamps may be used as well.

As described above, in the first embodiment, the value of Fp×M, that is the product of the F-number Fp and the projection magnification M of the projection optical system 3, is set to satisfy a requirement that it should be no greater than 400, more specifically it should be no greater than 395 or 393 in light of the values obtained by the results of experiment. In addition to this, the ratio of the thickness (DTF, DTL) of the diffusion layer 51a or 52a to the thickness (TF, TL) of the Fresnel lens or the lenticular lens of the transmissive screen 5, is set to be less than 0.150 and no greater than 0.138. Namely, the thickness (DTF, DTL) of the diffusion layer is set to be less than 300 μm and no greater than 275 μm. Thus, speckle noise and scintillation on the transmissive screen 5 are effectively reduced even when a high-brightness light source is used.

Furthermore, by the use of the laser light sources 11, the first embodiment realizes a long-lasting optical system that achieves good color reproducibility. Still further, by the provision of the light diffusing element 44 in the illumination optical system 4, the first embodiment efficiently reduces speckle noise and scintillation. Also, by the use of the light intensity equalizer 41 for providing uniformity in light beams emitted from the light-collecting optical system 1, the first embodiment provides favorable images with no nonuniformity in illumination level while reducing speckle noise and scintillation.

As described above, the first embodiment makes the following setting in order for the angle of divergence of light entering the transmissive screen 5 to fall within a predetermined range. That is, the product of the F-number Fp and the projection magnification of the projection optical system 3 (value of Fp×M) is set to satisfy a requirement that it should be no greater than 400, more specifically it should be no greater than 395 or 393 in light of the values obtained by the results of experiment.

In addition to this, the ratio of the thickness (DTF, DTL) of the diffusion layer, that is the thickness of the diffusion layer 51a or 52a of the transmissive screen 5, to the thickness (TF, TL) of the Fresnel lens or the lenticular lens, is set to be less than 0.150 and no greater than 0.138. Namely, the thickness (DTF, DTL) of the diffusion layer is set to be less than 300 μm and not greater than 275 μm. Thus, even when high-brightness light is projected onto the transmissive screen 5, speckle noise or scintillation is effectively reduced to thereby achieve high quality of images to be displayed.

### Second Embodiment

A second embodiment of the present invention will be described by referring to FIGS. 9 to 11 and 16. In the second embodiment, at least two diffusion layers are arranged in the transmissive screen 5, and a distance TFLo between the light incident surface of a first diffusion layer and the light exit surface of a second diffusion layer (distance between the outer surfaces of the diffusion layers, namely maximum distance between the diffusion layers) is set to fall within a predetermined range.

FIG. 16 shows the relationship of the distance TFLo between the light incident surface of the first diffusion layer 51a and the light exit surface of the second diffusion layer 52a shown in FIGS. 9 to 11 with speckle noise or scintillation observed on the transmissive screen 5. As seen from FIG. 16, scintillation is reduced effectively when the distance TFLo is set to be no less than 5 mm. In the present embodiment, the distance TFLo is defined such that scintillation is lower than a predetermined value (scintillation allowable range), namely, such that scintillation falls within its allowable range.

The values shown in FIG. 16 are obtained from experiments conducted under conditions that the product of the F-number Fp and the projection magnification M of a projection optical system is 420, the thickness DTF and the haze value of the diffusion layer 51a of the Fresnel lens 51 are 275 μm and 43%, respectively, and the thickness DTL and the haze value of the diffusion layer 52a of the lenticular lens 52 are 275 μm and 90% respectively.

As already mentioned, the distance TFLo defines a distance between the outer surfaces of the first and second diffusion layers 51a and 52a. Scintillation is investigated next by defining a distance TFLi between the inner surfaces of the first and second diffusion layers 51a and 52a.

As shown in FIGS. 9 to 11, at least two diffusion layers are arranged in the transmissive screen 5.

Furthermore, the diffusion layer 51a of the Fresnel lens 51 nearest the light incident surface of the transmissive screen 5 is defined as a first diffusion layer, and the diffusion layer 52a of the lenticular lens 52 nearest the light exit surface of the transmissive screen 5 is defined as a second diffusion layer. Then, the relationship among the distance TFLi between the light exit surface of the first diffusion layer and the light incident surface of the second diffusion layer (distance between the inner surfaces of the diffusion layers, namely minimum distance between the diffusion layers), speckle noise or scintillation, and a resolution level is considered. The internal distance TFLi mentioned in the present embodiment is optically expressed in the form of air thickness.

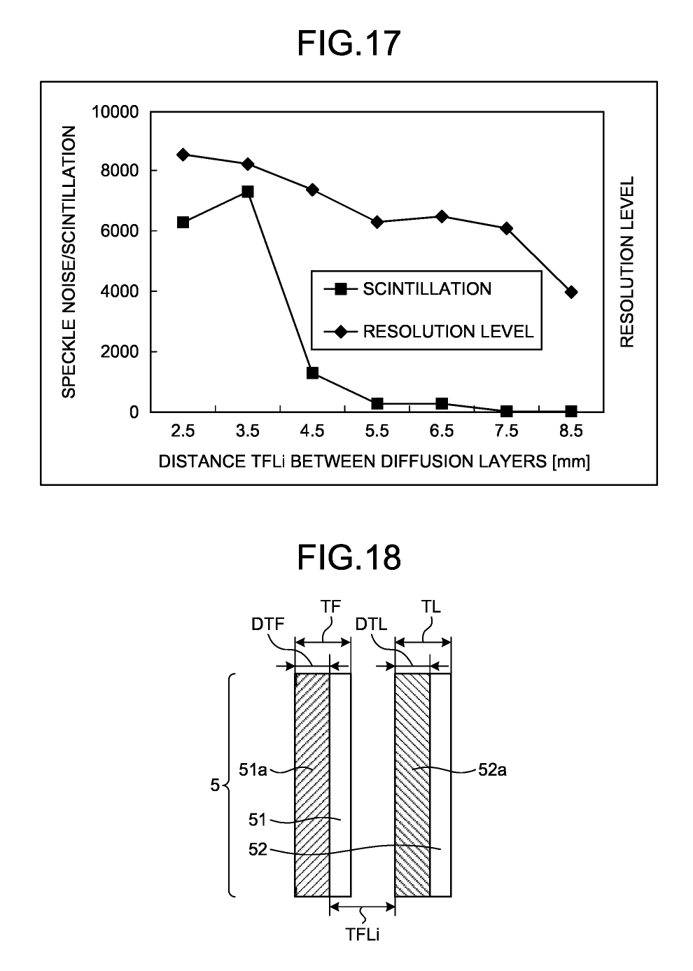

FIG. 17 shows the relationship among the distance TFLi between the light exit surface of the first diffusion layer 51a and the light incident surface of the second diffusion layer 52a shown in FIGS. 9 to 11, speckle noise or scintillation observed on the transmissive screen 5, and the resolution level of the transmissive screen 5. The values shown in FIG. 17 are obtained from experiments conducted under conditions that the product of the F-number Fp and the projection magnification M of a projection optical system is 420, the thickness DTF and the haze value of the diffusion layer 51a of the Fresnel lens 51 are 275 μm and 43%, respectively, and the thickness DTL and the haze value of the diffusion layer 52a of the lenticular lens 52 are 275 μm and 90%, respectively. In the legends of FIG. 17, speckle noise and scintillation are expressed collectively merely as scintillation due to a lack of space. Furthermore, speckle noise and scintillation are indicated by squares (lower plot), and a resolution level is indicated by rhombuses (upper plot).

It has been found from FIG. 17 that speckle noise or scintillation is reduced (favorable images are obtained) with an increase in the internal distance TFLi between the diffusion layers. However, it has also found that increase in the internal distance TFLi in turn causes reduction in a resolution level. Reduction in resolution levels increases the degree of blurring. Accordingly, a resolution level is lowered as shown in FIG. 17. That is, image quality degrades with reduction in a resolution level.

Accordingly, increasing the distance TFLi between the diffusion layers is effective for reducing speckle noise or scintillation. However, a projection display device should be configured such that the distance TFLi is optimized in order to suppress reduction in a resolution level. FIG. 17 shows that the internal distance TFLi is preferably from 4.5 mm to 7.5 mm.

As described above, in the second embodiment, the transmissive screen 5 is configured such that the distance TFLo between the light incident surface of the first diffusion layer 51a and the light exit surface of the second diffusion layer 52a is no less than 5 mm, or such that the distance TFLi between the light exit surface of the first diffusion layer 51a and the light incident surface of the second diffusion layer 52a is from 4.5 mm to 7.5 mm. Accordingly, speckle noise or scintillation is reduced to thereby achieve high quality of images to be displayed.

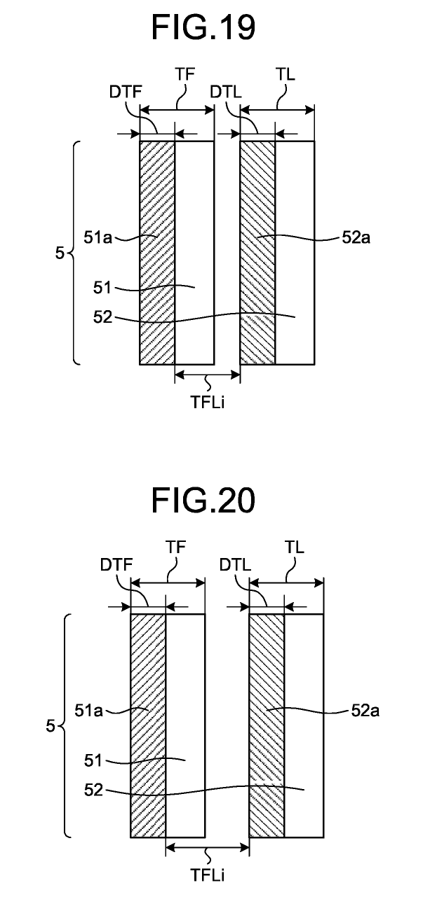

Next, the relationship between the internal distance TFLi between the diffusion layers with the thicknesses of the diffusion layers 51a and 52a is considered. FIGS. 18 to 20 each show how the internal distance TFLi is defined with the increased thicknesses DTF and DTL of the diffusion layers 51a and 52a with respect to the diffusion layers 51a and 52a shown in FIG. 9 that are arranged on the respective incident sides of the Fresnel lens 51 and the lenticular lens 52. In FIG. 18, the diffusion layers 51a and 52a are increased in thickness but the thicknesses TF and TL of the Fresnel lens screen 51 and the lenticular lens 52 do not change. In this case, the internal distance TFLi is shortened. In FIG. 19, the diffusion layers 51a and 52a are increased in thickness and the thicknesses TF and TL are also increased. In this case, the Fresnel lens screen 51 and the lenticular lens 52 come closer to each other and the internal distance TFLi is shortened accordingly. In FIG. 20, the diffusion layers 51a and 52a are increased in thickness as in the structure shown in FIG. 18, and the thicknesses TF and TL are also increased. The internal distance TFLi is, however, maintained at the same level as that in FIG. 9.

As shown in FIGS. 18 to 20, the internal distance TFLi is shortened with increase in the thicknesses DTF and DTL of the diffusion layers 51a and 52a. Or alternatively, with increase in the thicknesses DTF and DTL of the diffusion layers 51a and 52a, the total thickness of the transmissive screen 5 is increased when the internal distance TFLi is maintained at the same level. In the structures shown in FIGS. 18 to 20, the cases where the diffusion layers 51a and 52a are arranged on the respective incident sides of the Fresnel lens 51 and the lenticular lens 52 are considered. The same results are obtained when the diffusion layers 51a and 52a are arranged on the respective light exit sides thereof as shown in FIG. 10, or when they are arranged on a different combination of the incident side and the light exit side.

The internal distance TFLi between the diffusion layers, speckle noise and scintillation, and a resolution level are closely related to one another as shown in FIG. 17. The internal distance TFLi should be from 4.5 mm to 7.5 mm in order to achieve favorable performance. In this case, the total thickness of the transmissive screen 5 is increased when the diffusion layers 51a and 52a are increased in thickness as shown in FIG. 20.

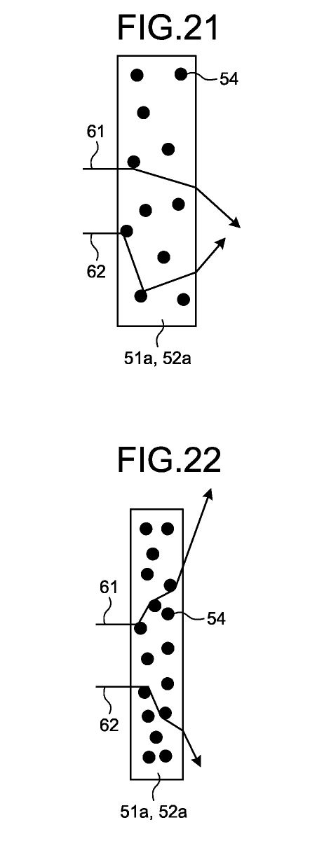

FIGS. 21 and 22 conceptually illustrate how speckle noise and scintillation are reduced in accordance with a change in the thickness of the diffusion layer 51a or 52a. The diffusion layer 51a or 52a contains a diffusing material, and the amount of the diffusion material contained is expressed by a haze value (in percentage). The diffusion layer 51a or 52a has a thickness that is different between FIGS. 21 and 22, and has a haze value that is the same between FIGS. 21 and 22. Again, the diffusion layer 51a or 52a has a thickness (that is, an optical path length) that is different between FIGS. 21 and 22. This means that the smaller thickness of the diffusion layer 51a or 52a shown in FIG. 22 results in a shorter optical length path. In order to compensate for reduction in an optical path length, a rate of filling with a diffusing material should be increased to maintain a haze value at the same level.

When the diffusion layer 51a or 52a is reduced in thickness so as to increase a rate of filling with a diffusing material as shown in FIG. 22, light beams 61 and 62 entering the diffusion layer 51a or 52a are diffused by diffusing elements 54 with higher probability. Accordingly, the light beams 61 and 62 emitted to an observer have more irregularities than those in the case of FIG. 21 where the diffusion layer 51a or 52a has a greater thickness, thereby more effectively reducing speckle noise and scintillation.

Increase in the haze value H1 or H2 achieves increase in a rate of filling with a diffusing material despite the greater thickness of the diffusion layer 51a or 52a. However, increase in the haze value H1 or H2 is undesirable as it in turn reduces brightness as well as a resolution level.

FIG. 17 shows the results obtained with change in the internal distance TFLi between the diffusion layers as a result only of the changes in the thicknesses of the diffusion layers 51a and 52a as shown in FIG. 18. However, the same results are obtained from the structures shown in FIGS. 19 and 20 about the relationship among a distance TFL between diffusion layers, speckle noise or scintillation, and a resolution level.

The values shown in FIG. 17 are obtained from experiments conducted under conditions that the product of the F-number Fp and the projection magnification M of a projection optical system is 420, the haze value of the diffusion layer 51a of the Fresnel lens 51 is 43%, and the haze value of the diffusion layer 52a of the lenticular lens 52 is 90%. Even when the product of the F-number Fp and the projection magnification M of the projection optical system is smaller, speckle noise and scintillation are reduced more effectively as long as the distance TFL between the diffusion layers is from 4.5 mm to 7.5 mm.

### Third Embodiment

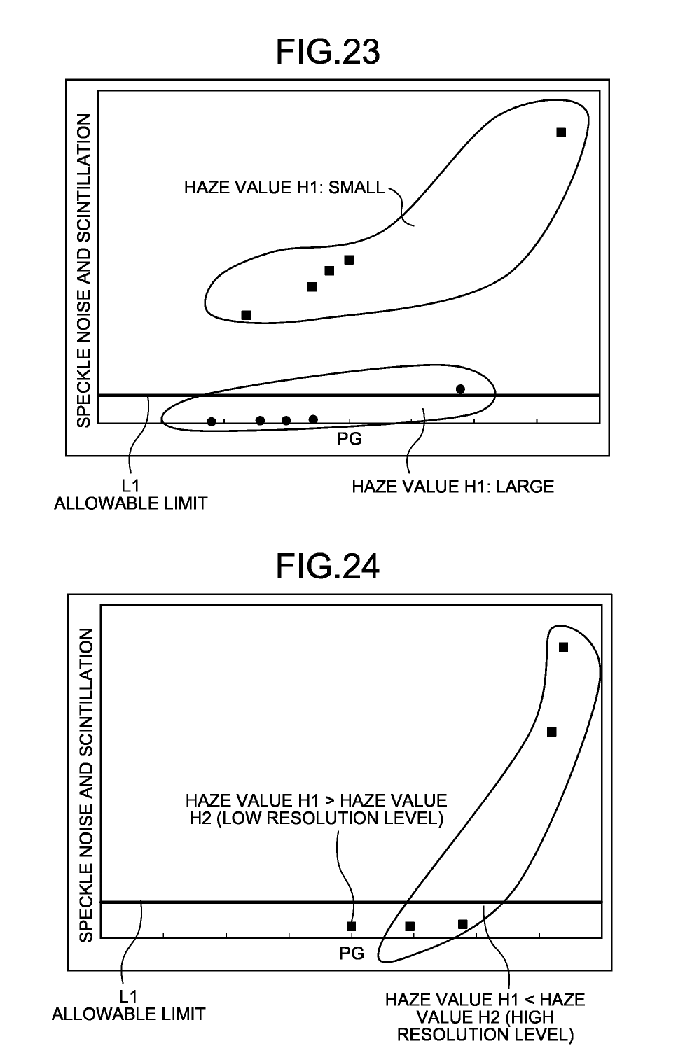

A third embodiment of the present invention will be described by referring to FIGS. 23 and 24. In the third embodiment, at least two diffusion layers are arranged in the transmissive screen 5, and the diffusion rate (haze value) of each of the diffusion layers is set to fall within a predetermined range.

The diffusion layers 51a and 52a of the Fresnel lens 51 and the lenticular lens 52 each contain a diffusing material, and the amount of the diffusing material contained may be expressed by a haze value (in percentage). Here, the haze value of the diffusion layer 51a is defined as a haze value H1, and that of the diffusion layer 52a is defined as a haze value H2.

Increase in the haze value H1 or H2 of the diffusion layer 51a or 52a reduces speckle noise or scintillation observed on the transmissive screen 5. However, increase in the haze value H1 disadvantageously reduces forward brightness and lowers a resolution level. Increase in the haze value H2 also reduces forward brightness. Furthermore, the haze value H2 reaching or exceeding a predetermined value is less effective in reducing speckle noise or scintillation.

Described next are a peak gain (PG) indicative of the brightness of the transmissive screen 5, and to which degree glare (speckle noise and scintillation) is reduced when the haze values H1 and H2 of the diffusion layers 51a and 52a are varied. FIG. 23 shows results of examination of PG and a degree of reduction in glare obtained by varying a haze value. FIG. 23 represents the relationship among the haze value H1 of the diffusion layer 51a, PG, and a degree of reduction in glare (speckle noise and scintillation) with the corresponding haze value H1. The haze value H1 of the diffusion layer 51a used in the examination was specifically 40% as a smaller haze value, and was 72% as a larger haze value. At this time, the lenticular lens 52 combined with the Fresnel lens 51 had five variations defined by the haze value H2 of the diffusion layer 52a that ranges from 80% to 95%.

The two variations of the Fresnel lens 51 including the one with the smaller haze value H1 and the other with the higher haze value H1 of the diffusion layer 51a were combined in various ways with the five variations of the lenticular lens 52 with different haze values H2 of the diffusion layer 52a. Then, PG, and a degree of reduction in speckle noise and scintillation in these combinations were observed.

As a result, when the haze value H1 of the diffusion layer 51a was smaller, PG was reduced in some cases according to the variation of the lenticular lens 52. However, when the haze value H1 of the diffusion layer 51a was smaller, speckle noise and scintillation were never reduced to an allowable level (allowable limit L1 of speckle noise and scintillation) even in the combinations of the Fresnel lens 51 with any variations of the lenticular lens 52.

In contrast, when the haze value H1 of the diffusion layer 51a was larger, speckle noise and scintillation were reduced significantly to reach the allowable limit L1 in many cases as long as the haze value H2 of the diffusion layer 52a was greater than a predetermined value (as long as PG was small). Accordingly, it has been found that increase in the haze value H1 of the diffusion layer 51a more effectively reduces speckle noise and scintillation.

Next, the lenticular lens 52 with the haze value H2 of the diffusion layer 52a being 80% is combined in various ways with five variations of the Fresnel lens 51. Then, PG, a degree of reduction in speckle noise and scintillation, and a resolution level in these combinations were observed. FIG. 24 shows results of examination of PG, a degree of reduction in glare, and a resolution level obtained by varying a haze value. Specifically, FIG. 24 shows the relationship among the haze value H1 of the diffusion layer 51a, PG, a degree of reduction in speckle noise or scintillation, and a resolution level with the corresponding haze value H1.

The Fresnel lens 51 has five variations defined by the haze value H1 of the diffusion layer 51a that ranges from 40% to 82%. Speckle noise and scintillation are reduced effectively with the haze value H1 of 82% (higher than the haze value H2 of the diffusion layer 52a that is 80%). In this case, however, a resolution level is severely lowered. Accordingly, it has been found that, while increase in the haze value H1 of the diffusion layer 51a effectively reduces speckle noise and scintillation, increase in the haze value H1 to a level higher than the haze value H2 of the diffusion layer 52a lowers a resolution level. Accordingly, setting the haze value H1 of the diffusion layer 51a to be smaller than the haze value H2 of the diffusion layer 52a effectively reduces speckle noise and scintillation while providing a favorable resolution level. Thus, in the present embodiment, the haze value H1 is increased to a level that does not exceed the level of the haze value H2.

As described above, in the third embodiment, the transmissive screen 5 is configured by using the diffusion layer 51a the haze value H1 of which is set to a high level but that does not exceed the level of the haze value H2 of the diffusion layer 52a. As a result, speckle noise or scintillation is reduced to thereby achieve high quality of images to be displayed.

### Fourth Embodiment

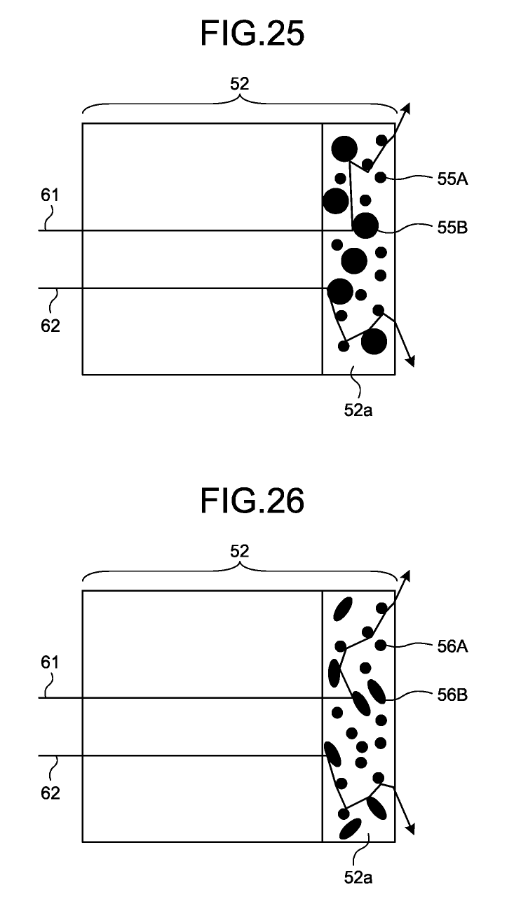

A fourth embodiment of the present invention will be described by referring to FIGS. 25 and 26. In the fourth embodiment, the diffusion layer 52a of the lenticular lens 52 is configured to contain at least two types of diffusing materials (diffusing elements).

FIGS. 25 and 26 each show the structure of an optical system of a projection display device according to the fourth embodiment of the present invention. FIGS. 25 and 26 each conceptually show the structure of the diffusion layer 52a of the lenticular lens 52. The transmissive screen 5 functioning as an optical system of the projection display device 101 includes the lenticular lens 52, and the diffusion layer 52a of the lenticular lens 52 contains at least two types of diffusing materials. The diffusion layer 52a is configured by combining diffusing materials of different substances (different refractive indexes), different sizes, different shapes and the like.

FIG. 25 shows an example of a diffusion layer containing diffusing materials of different sizes. FIG. 26 shows an example of a diffusion layer containing diffusing materials of different sizes and shapes. The diffusion layer 52a of the lenticular lens 52 shown in FIG. 25 contains at least two types of diffusing materials 55A and 55B of different sizes. The diffusion layer 52a of the lenticular lens 52 shown in FIG. 26 contains at least two types of diffusing materials 56A and 56B of different sizes and different shapes. According to this configuration, light beams 61 and 62 entering the lenticular lens 52 and emitted as diffusion light to an observer have more irregularities than those in the case where the diffusion layer 52a contains a single type of diffusing material.

As described above, in the projection display device 101 of the fourth embodiment, the diffusion layer 52a of the lenticular lens 52 is configured to contain at least two types of diffusing materials. Accordingly, the light beams 61 and 62 entering the lenticular lens 52 and emitted as diffusion light to an observer have irregularities. As a result, speckle noise and scintillation are more effectively reduced to thereby achieve high quality of images to be provided.

### Fifth Embodiment

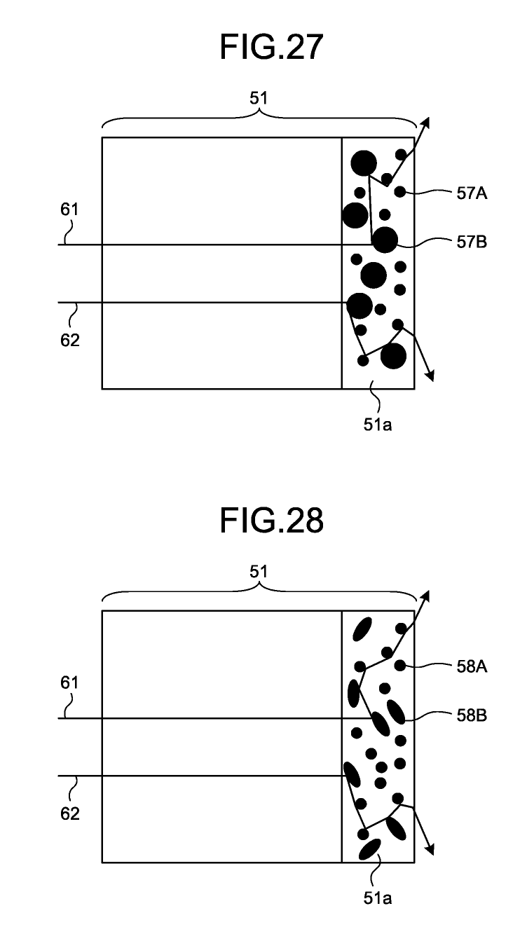

A fifth embodiment of the present invention will be described by referring to FIGS. 27 and 28. In the fifth embodiment, the diffusion layer 51a of the Fresnel lens 51 is configured to contain at least two types of diffusing materials (diffusing elements).

FIGS. 27 and 28 each show the structure of an optical system of a projection display device according to the fifth embodiment of the present invention. FIGS. 27 and 28 each conceptually show the structure of the diffusion layer 51a of the Fresnel lens 51. The transmissive screen 5 functioning as an optical system of the projection display device 101 is configured to include the Fresnel lens 51, and the diffusion layer 51a of the Fresnel lens 51 contains at least two types of diffusing materials. The diffusion layer 51a is configured by combining diffusing materials of different substances (different refractive indexes), different sizes, different shapes and the like.

FIG. 27 shows an example of a diffusion layer containing diffusing materials of different sizes. FIG. 28 shows an example of a diffusion layer containing diffusing materials of different sizes and shapes. The diffusion layer 51a of the Fresnel lens 51 shown in FIG. 27 contains at least two types of diffusing materials 57A and 57B of different sizes. The diffusion layer 51a of the Fresnel lens 51 shown in FIG. 28 contains at least two types of diffusing materials 58A and 58B of different sizes and different shapes. According to this configuration, light beams 61 and 62 entering the Fresnel lens 51 and emitted as diffusion light to an observer have more irregularities than those in the case where the diffusion layer 51a contains a single type of diffusing material.

As described above, in the projection display device 101 of the fifth embodiment, the diffusion layer 51a of the Fresnel lens 51 contains at least two types of diffusing materials. Accordingly, the light beams 61 and 62 entering the Fresnel lens 51 and emitted as diffusion light to an observer have irregularities. As a result, speckle noise and scintillation are more effectively reduced to thereby achieve high quality of images to be provided.

### Sixth Embodiment

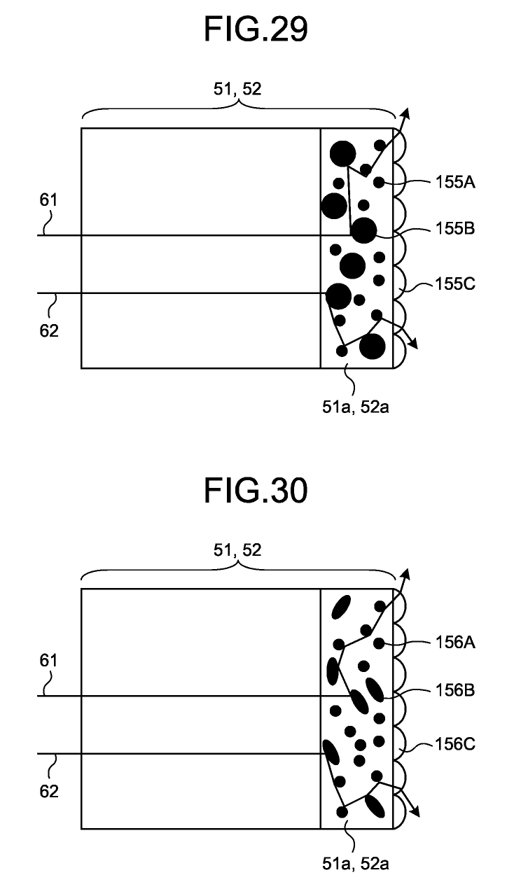

A sixth embodiment of the present invention will be described by referring to FIGS. 29 to 32. In the embodiments described so far, the diffusion layers 51a and 52a of the Fresnel lens 51 and the lenticular lens 52 each contain diffusing materials of different substances, shapes and sizes. In the present embodiment, a diffusing element is added to the light exit surface of the Fresnel lens 51 or the lenticular lens 52.

FIGS. 29 to 32 each show the structure of an optical system of a projection display device according to the sixth embodiment of the present invention. FIGS. 29 to 32 each conceptually show the structure of the diffusion layer 51a or 52a of the Fresnel lens 51 or the lenticular lens 52. The transmissive screen 5 functioning as an optical system of the projection display device 101 is configured to include the Fresnel lens 51 or the lenticular lens 52, and the diffusion layer 51a or 52a of the Fresnel lens 51 or the lenticular lens 52 contains at least two types of diffusing materials (in FIGS. 29 to 32, three types of diffusing materials are shown). The diffusion layer 51a or 52a is configured by combining diffusing materials of different substances (different refractive indexes), different sizes, different shapes and the like with a diffusion layer having a function of a lens.

The diffusion layer 51a or 52a of the Fresnel lens 51 or the lenticular lens 52 shown in FIG. 29 contains two types of diffusing materials 155A and 155B of different sizes, and a diffusing element 155C having a lens structure. According to this configuration, light beams 61 and 62 entering the Fresnel lens 51 or the lenticular lens 52 and emitted as diffusion light to an observer have more irregularities than those in the case where the diffusion layer 51a or 52a contains a single type of diffusing element.

Likewise, the diffusion layer 51a or 52a of the Fresnel lens 51 or the lenticular lens 52 shown in FIG. 30 contains two types of diffusing materials 156A and 156B of different sizes and shapes, and a diffusing element 156C having a lens structure. According to this configuration, light beams 61 and 62 entering the Fresnel lens 51 or the lenticular lens 52 and emitted as diffusion light to an observer have more irregularities than those in the case where the diffusion layer 51a or 52a contains a single type of diffusing element.

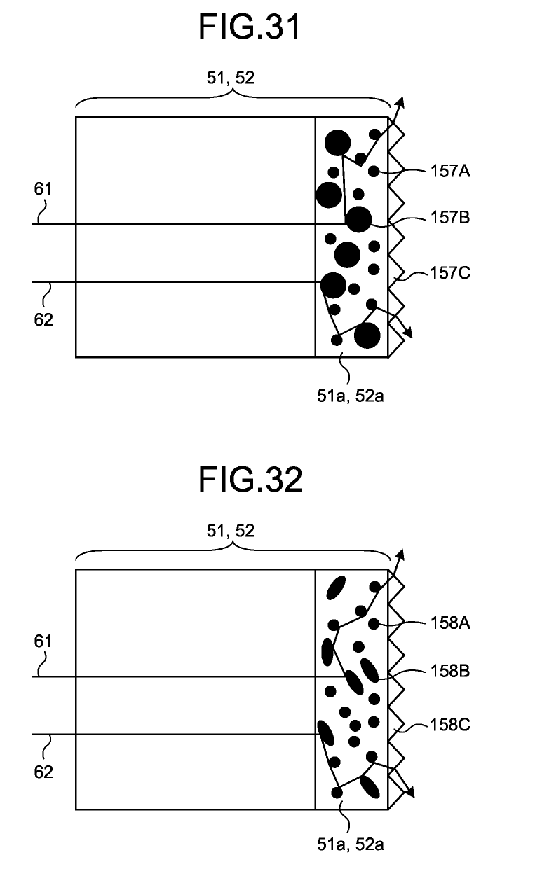

Likewise, the diffusion layer 51a or 52a of the Fresnel lens 51 or the lenticular lens 52 shown in FIG. 31 contains two types of diffusing materials 157A and 157B of different sizes, and a diffusing element 157C having a prism lens structure. According to this configuration, light beams 61 and 62 entering the Fresnel lens 51 or the lenticular lens 52 and emitted as diffusion light to an observer have more irregularities than those in the case where the diffusion layer 51a or 52a contains a single type of diffusing element.

Likewise, the diffusion layer 51a or 52a of the Fresnel lens 51 or the lenticular lens 52 shown in FIG. 32 contains two types of diffusing materials 158A and 158B of different sizes and shapes, and a diffusing element 158C having a prism lens structure. According to this configuration, light beams 61 and 62 entering the Fresnel lens 51 or the lenticular lens 52 and emitted as diffusion light to an observer have more irregularities than those in the case where the diffusion layer 51a or 52a contains a single type of diffusing element.

In each of FIGS. 29 to 32, the diffusion layer 51a or 52a is shown to contain three different types of diffusing elements. However, the number of types of diffusing elements is not limited to three. Furthermore, while shown to be arranged on the light exist side of the Fresnel lens 51 or the lenticular lens 52 in each of FIGS. 29 to 32, a diffusing element is not necessarily arranged on the light exit side. Also, the diffusing elements 155C and 156C shown in FIGS. 29 and 30 each have a lens structure, and the diffusing elements 157C and 158C shown in FIGS. 30 and 31 each have a prism lens structure. However, the lens structures of the diffusing elements are not limited to those shown in FIGS. 29 to 32.

As described above, in the projection display device 101 of the sixth embodiment, the diffusion layer 51a or 52a of the Fresnel lens 51 or the lenticular lens 52 is configured to contain at least two types of diffusing elements. Accordingly, the light beams 61 and 62 entering the Fresnel lens 51 or the lenticular lens 52 and emitted as diffusion light to an observer have irregularities. As a result, speckle noise and scintillation are more effectively reduced to thereby achieve high quality of images to be provided.

### Seventh Embodiment

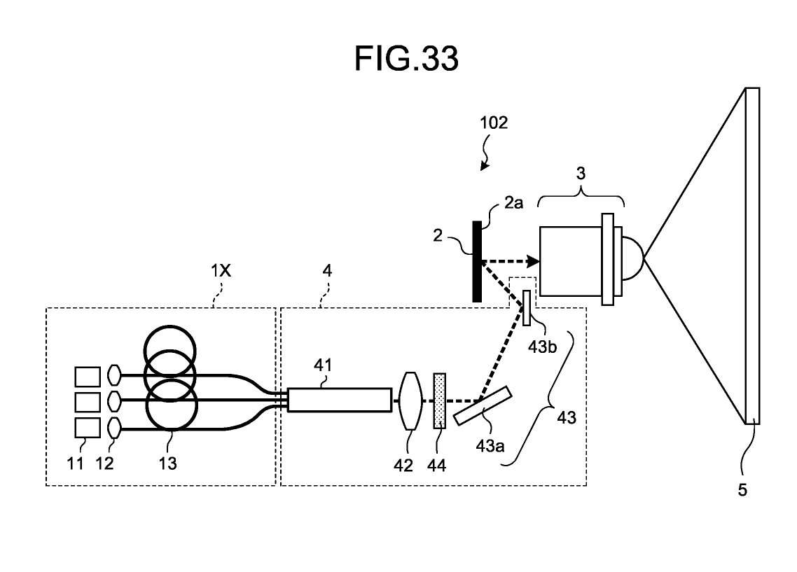

A seventh embodiment of the present invention will be described by referring to FIG. 33. In the seventh embodiment, optical fibers 13 are added to the light-collecting optical system 1. FIG. 33 shows the structure of a projection display device according to the seventh embodiment. Constituent elements shown in FIG. 33 having the same functions as those of the corresponding elements of the projection display device 101 of the first embodiment shown in FIG. 1 are designated by the same reference numerals, and the same description thereof is not given repeatedly.

A light-collecting optical system 1X of a projection display device 102 is configured to include laser light sources 11 of multiple colors (in FIG. 33, three colors), a plurality of (in FIG. 33, three) light-collecting lenses (light-collecting parts) 12 composed of one or a plurality of lenses or mirrors for collecting light beams emitted from the laser light sources 11, and a plurality of (in FIG. 33, three) optical fibers 13 for guiding light beams emitted from the light-collecting lenses 12 to an illumination optical system 4.

In the light-collecting optical system 1X, each of the laser light sources 11 has a one-to-one correspondence with each of the light-collecting lenses 12 and each of the optical fibers 13. Accordingly, a light beam emitted from one of the laser light sources 11 is transferred through the corresponding light-collecting lens 12 and the corresponding optical fiber 13 to the illumination optical system 4.

The illumination optical system 4 includes a light intensity equalizer 41 for providing uniformity in the intensity distribution of light beams emitted from the light-collecting optical system 1X (optical fibers 13), a relay lens group 42, a diffusing element 44, and a mirror group 43 composed of a first mirror 43a and a second mirror 43b. In the illumination optical system 4, light beams emitted from the light intensity equalizer 41 are guided by the relay lens group 42 and the mirror group 43 to the reflective light modulator 2.

As described above, in the seventh embodiment, light beams emitted from the laser light sources 11 are guided through the optical fibers 13 to the illumination optical system 4. This provides flexibility in the arrangement of an optical system, and the resultant structure of the optical system allows admission of light beams at a high rate. Also, as a result of multiple reflection of light beams inside the optical fibers 13, speckle noise and scintillation are reduced to thereby provide uniformity in images.

A projection display device may be constructed by combining the structures of the first to seventh embodiments. In this case, the projection display device is formed of a simple structure capable of reducing speckle noise and scintillation to achieve high quality of images to be displayed.

Although the invention has been described with respect to specific preferred embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projection display device for displaying an image by projecting the image onto a transmissive screen from the rear thereof, the projection display device comprising:
a light source for emitting light;
an illumination optical system for causing a light beam emitted from the light source to propagate through a predetermined optical path, and guiding the light beam to the transmissive screen;
an image display element for forming an image on a region to be illuminated with a light beam guided by the illumination optical system, the image being intended to be displayed on the transmissive screen;
a projection optical system for enlarging the image formed on the region of the image display element, and projecting the enlarged image on the transmissive screen; and
the transmissive screen including a Fresnel lens for converting incident light to light of substantially parallel rays and causing the converted light to exit the Fresnel lens, the transmissive screen also including a lenticular lens for receiving light exiting the Fresnel lens, and causing the received light to exit the lenticular lens as predetermined diffusion light, wherein
the projection optical system is configured such that a product of an F-number and a projection magnification of the projection optical system is less than 400,
the Fresnel lens includes a first light diffusion layer for diffusing incident light and causing resultant light to exit the first light diffusion layer as first diffusion light, and
the lenticular lens includes a second light diffusion layer for further diffusing the first diffusion light and causing resultant light to exit the second light diffusion layer as second diffusion light, the second light diffusion layer having a thickness of less than 300 μm.

2. The projection display device according to claim 1, wherein a distance between a light exit surface of the first light diffusion layer and a light incident surface of the second light diffusion layer is no less than 4.5 mm and no greater than 7.5 mm.

3. The projection display device according to claim 1, wherein the first light diffusion layer has a diffusion rate smaller than that of the second light diffusion layer.

4. The projection display device according to claim 1, wherein the second light diffusion layer contains at least two types of diffusing elements.

5. The projection display device according to claim 1, wherein the first light diffusion layer contains at least two types of diffusing elements.

6. The projection display device according to claim 1, wherein the light source is a laser light source.

7. The projection display device according to claim 6, wherein the illumination optical system includes a diffusing part for diffusing propagating light and transferring the light.

8. The projection display device according to claim 6, further comprising an optical fiber arranged between the light source and the illumination optical system, the optical fiber guiding a light beam emitted from the light source to the illumination optical system.

9. The projection display device according to claim 1, wherein the illumination optical system includes a light intensity equalizer for providing uniformity in the intensity of a light beam emitted from the light source.

10. The projection display device according to claim 1, further comprising a light-collecting optical system for guiding light emitted from the light source to the illumination optical system, and
wherein the light-collecting optical system includes a first polarization changing part for changing polarization of propagating light.

11. The projection display device according to claim 1, wherein the illumination optical system includes a second polarization changing part for changing the polarization of propagating light.

12. A projection display device for displaying an image by projecting the image onto a transmissive screen from the rear thereof, the projection display device comprising:
a light source for emitting light;
an illumination optical system for causing a light beam emitted from the light source to propagate through a predetermined optical path, and guiding the light beam to the transmissive screen;
an image display element for forming an image on a region to be illuminated with a light beam guided by the illumination optical system, the image being intended to be displayed on the transmissive screen;
a projection optical system for enlarging the image formed on the region of the image display element, and projecting the enlarged image on the transmissive screen; and
the transmissive screen including a Fresnel lens for converting incident light to light of substantially parallel rays and causing the converted light to exit the Fresnel lens, the transmissive screen also including a lenticular lens for receiving light exiting the Fresnel lens, and causing the received light to exit the lenticular lens as predetermined diffusion light, wherein
the projection optical system is configured such that a product of an F-number and a projection magnification of the projection optical system is less than 400,
the Fresnel lens includes a first light diffusion layer for diffusing incident light and causing resultant light to exit the first light diffusion layer as first diffusion light, and
the lenticular lens includes a second light diffusion layer for further diffusing the first diffusion light and causing resultant light to exit the second light diffusion layer as second diffusion light, the first light diffusion layer having a thickness of less than 300 μm.

13. The projection display device according to claim 12, wherein a distance between a light exit surface of the first light diffusion layer and a light incident surface of the second light diffusion layer is no less than 4.5 mm and no greater than 7.5 mm.

14. The projection display device according to claim 12, wherein the first light diffusion layer has a diffusion rate smaller than that of the second light diffusion layer.

15. The projection display device according to claim 12, wherein the second light diffusion layer contains at least two types of diffusing elements.

16. The projection display device according to claim 12, wherein the first light diffusion layer contains at least two types of diffusing elements.

17. The projection display device according to claim 12, wherein the light source is a laser light source.

18. The projection display device according to claim 17, wherein the illumination optical system includes a diffusing part for diffusing propagating light and transferring the light.

19. The projection display device according to claim 12, further comprising a light-collecting optical system for guiding light emitted from the light source to the illumination optical system, and
wherein the light-collecting optical system includes a first polarization changing part for changing polarization of propagating light.

20. The projection display device according to claim 12, wherein the illumination optical system includes a second polarization changing part for changing the polarization of propagating light.
